(19) United States
(12) Patent Application Publication
(10) Pub. No.: US 2007/0118057 A1
(43) Pub. Date: May 24, 2007

(54) Acoustic wave energy delivery device

(76) Inventor: Moshe Ein-Gal, Ramat Hasharon (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 11/281,591

(22) Filed: Nov. 18, 2005

(51) Int. Cl. A61H 1/00

(52) U.S. Cl. 601/4

(57) ABSTRACT

An acoustic wave energy delivery device including an acoustic wave energy transducer for generating an acoustic wave along an acoustic wave propagation axis, focusing apparatus for focusing the acoustic wave to a focal point, and acoustic wave reorientation apparatus adapted to modify a spatial orientation of the acoustic wave propagation axis with respect to the focal point, wherein a position of the focal point is constrained within a locus referred to as the focal point locus, and throughout modification of the spatial orientation of the acoustic wave propagation axis the acoustic wave remains focused within the focal point locus. The focal point locus may be constrained to a single focal point.

### FIELD OF THE INVENTION

The present invention relates generally to an acoustic wave energy delivery devices and particularly to such devices that modify a spatial orientation of an acoustic wave propagation axis with respect to a focal point.

### BACKGROUND OF THE INVENTION

It is well known to treat patients with extracorporeal acoustic waves (e.g., extracorporeal shockwave lithotripsy (ESL), and high intensity focused ultrasound (HIFU)). Typically, propagating waves manifest wave fronts along an acoustic wave propagation axis, which is usually a symmetry axis. The focused waves converge inside the treated object on a focal point designed to be on the symmetry axis.

The focal region, i.e., the volume near the focal point where significant energy is deposited, is typically characterized by a length (along the symmetry axis) greater than a width (in the plane perpendicular to the symmetry axis). In shockwave lithotripsy (SWL), for example, a large focal region width is desired in order to increase stone fragmentation. On the other hand, a short focal region length is desired in order to reduce damage to healthy tissue. However, focal regions of prior art electromagnetic shockwave transducers may be shaped as an elongated ellipsoid, having a long focal region length and a narrow focal region width. This leads to reduced fragmentation efficacy and increased tissue damage.

### SUMMARY OF THE INVENTION

The present invention seeks to provide novel acoustic wave energy delivery devices and methods, wherein the spatial orientation of the acoustic wave propagation axis is modified with respect to the focal point, as described in detail hereinbelow. The devices and methods may be used for increasing focal region width and reducing focal region length associated with acoustic transducers. There is thus provided in accordance with an embodiment of the invention an acoustic wave energy delivery device including an acoustic wave energy transducer for generating an acoustic wave along an acoustic wave propagation axis, focusing apparatus for focusing the acoustic wave to a focal point, and acoustic wave reorientation apparatus adapted to modify a spatial orientation of the acoustic wave propagation axis with respect to the focal point, wherein a position of the focal point is constrained within a locus referred to as the focal point locus, and throughout modification of the spatial orientation of the acoustic wave propagation axis the acoustic wave remains focused within the focal point locus. The focal point locus may be constrained to a single focal point.

The focal point locus is characterized by a focal region length along the acoustic wave propagation axis and by a focal region width in a plane perpendicular to the acoustic wave propagation axis. The acoustic wave reorientation apparatus may modify the spatial orientation of the acoustic wave propagation axis so as to reduce the focal region length and/or increase the focal region width.

In accordance with an embodiment of the invention the acoustic wave reorientation apparatus may move the acoustic wave propagation axis with respect to the focal point locus.

Further in accordance with an embodiment of the invention the acoustic wave energy transducer may include a plurality of acoustic wave energy transducers with corresponding focusing apparatus, each acoustic wave energy transducer being capable of generating an acoustic wave which each corresponding focusing apparatus focuses to the focal point locus, wherein each acoustic wave energy transducer has a different spatial orientation with respect to the focal point locus, wherein the acoustic wave reorientation apparatus is adapted to selectively turn on and off the acoustic wave energy transducers in accordance with a treatment plan.

In accordance with an embodiment of the invention the focusing apparatus may include an acoustic lens and the acoustic wave reorientation apparatus may move the acoustic lens in order to modify the spatial orientation of the acoustic wave propagation axis with respect to the focal point locus.

In accordance with an embodiment of the invention the focusing apparatus may include an acoustic reflector and the acoustic wave reorientation apparatus may move the acoustic reflector in order to modify the spatial orientation of the acoustic wave propagation axis with respect to the focal point locus.

An image acquisition device may be provided to acquire images of the focal point locus. The acoustic wave reorientation apparatus may move the image acquisition device with respect to the focal point locus.

There is also provided in accordance with an embodiment of the invention a method for delivery of acoustic wave energy including generating an acoustic wave along an acoustic wave propagation axis, focusing the acoustic wave to a focal point, and modifying a spatial orientation of the acoustic wave propagation axis with respect to the focal point, wherein a position of the focal point is constrained within a locus referred to as the focal point locus, and throughout modification of the spatial orientation of the acoustic wave propagation axis the acoustic wave remains focused within the focal point locus. The method may include reducing the focal region length and/or increasing the focal region width.

### BRIEF DESCRIPTION OF THE DRAWINGS

The present invention will be understood and appreciated more fully from the following detailed description taken in conjunction with the drawings in which:

FIG. 1 is a simplified schematic illustration of an acoustic wave energy delivery device, constructed and operative in accordance with an embodiment of the present invention;

FIG. 2 is a simplified block diagram of components of the acoustic wave energy delivery device of FIG. 1;

FIG. 3 is a simplified schematic illustration of the acoustic wave energy delivery device of FIG. 1, showing the focal region length along the acoustic wave propagation axis and the focal region width in a plane perpendicular to the acoustic wave propagation axis; and

FIG. 4 is a simplified schematic illustration of an acoustic wave energy delivery device, constructed and operative in accordance with another embodiment of the present invention.

### DETAILED DESCRIPTION OF EMBODIMENTS

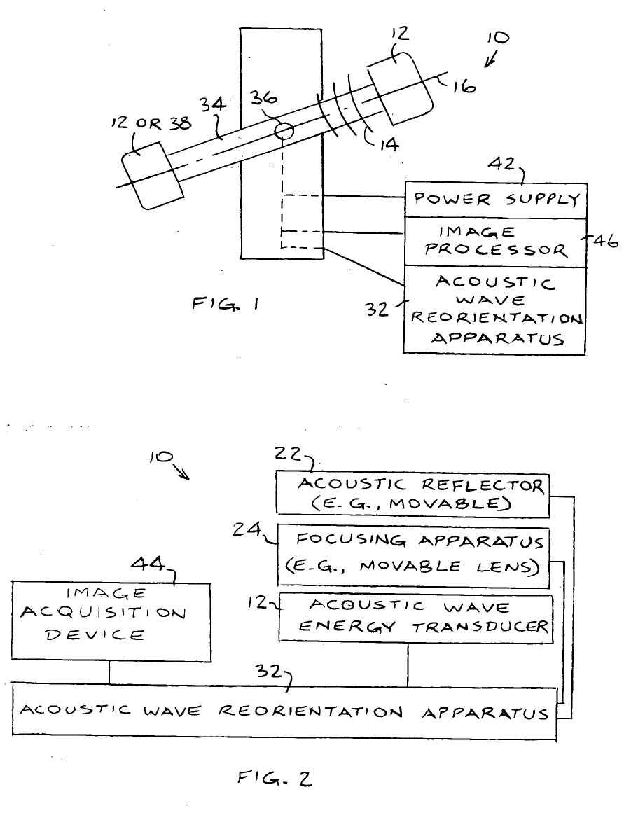

Reference is now made to FIGS. 1-3, which illustrate an acoustic wave energy delivery device 10, constructed and operative in accordance with an embodiment of the present invention.

The acoustic wave energy delivery device 10 may include an acoustic wave energy transducer 12 for generating an acoustic wave 14 along an acoustic wave propagation axis 16.

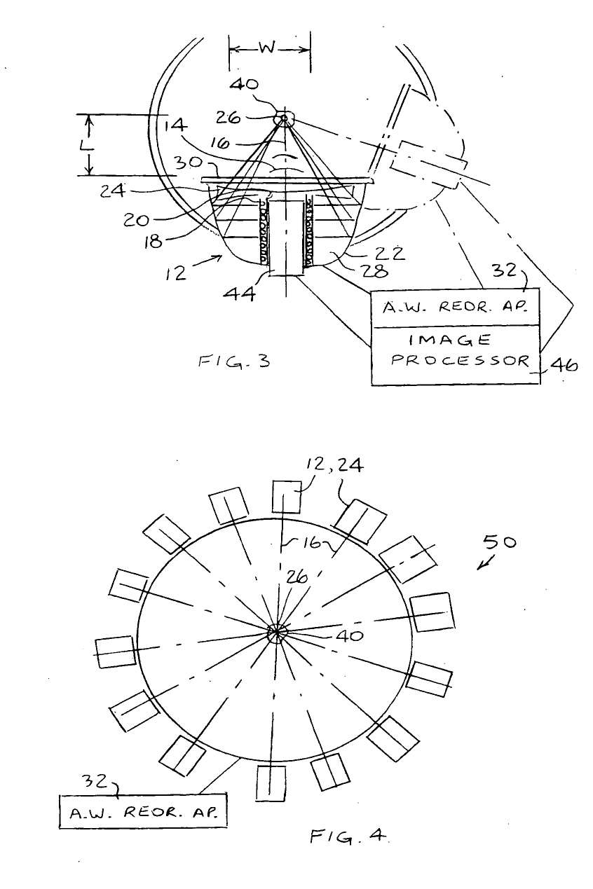

Referring particularly to FIG. 3, acoustic wave energy transducer 12 may be a non-point acoustic wave transducer with a repulsive member 18 disposed on an outer contour of a support 20, which is shown as cylindrical but may be other shapes, such as conical. Repulsive member 18 may generate an energy (e.g., acoustic) wave that emanates outwards from support 20. For example, repulsive member 18 may comprise a coil or membrane mounted on support 20, as is known in the art. Repulsive member 18 may be pushed or repelled, giving rise to outwardly propagating waves. An acoustic reflector 22, such as a parabolic reflector, may reflect the waves which may be focused by focusing apparatus 24 to a focal point 26 situated on acoustic wave propagation axis 16, which is typically, although not necessarily, an axis of symmetry. The inner volume of reflector 22 may be filled with a propagation liquid 28 (e.g., water), and the open end of reflector 22 may be covered with a membrane 30. The acoustic wave energy transducer 12 may be placed against or near a target in a patient, which it is desired to treat, such that focal point 26 is at the target. Waves generated by acoustic wave energy transducer 12 may propagate through propagation liquid 28 and membrane 30 towards the focal point 26 located in the target.

As is well known in the art, many other acoustic wave energy transducers may be used to propagate acoustic waves (or shockwaves, the terms being used interchangeably throughout), and the invention may be carried out by any of these transducers and others. Examples of suitable transducers include, but are not limited to, a point source and ellipsoidal reflector, wherein the point source typically comprises electrohydraulic apparatus. Fast discharges of electrical energy between tips of closely spaced electrodes give rise to a sequence of spherical waves in the propagation liquid. The electrodes are arranged with respect to the ellipsoidal reflector, which has two focal points. The electrical energy is discharged at the first focus, and the waves are focused onto the second focus.

Another example is a planar source and acoustic lens. A planar source typically comprises electromagnetic apparatus. A thin circular membrane applies pressure to the propagation liquid by being jolted or repelled away from a planar coil. Fast discharges of electrical energy into the coil and the associated rapid changes in the magnetic field induce currents in the membrane, turning it into a magnet with a polarization opposite to that of the coil. The ensuing repulsions of the membrane, which is in close contact with the propagation liquid, generate the acoustic waves. The waves are then focused (e.g., by the acoustic lens) to the target located at the focus of the lens.

Another example is a spherical source. Spherical waves may be generated by an array of piezo-electric transducers or by an electromagnetic approach with a spherical membrane being repulsed inwardly into the propagation liquid.

In accordance with an embodiment of the present invention acoustic wave reorientation apparatus 32 is provided that can modify a spatial orientation of the acoustic wave propagation axis 16 with respect to the focal point 26. For example, in the illustrated embodiment of FIG. 1, the acoustic wave energy transducer 12 may be mounted on a gantry arm 34 that pivots about a pivot 36. Another acoustic wave energy transducer 12 may be mounted on the opposite end of the gantry arm 34 or instead, a counterweight 38 may be mounted on the opposite end of the gantry arm 34. The acoustic wave reorientation apparatus 32 may include a servomotor (e.g., brushless) operatively connected to gantry arm 34 capable of rotating gantry arm 34 and acoustic wave energy transducer 12 therewith about pivot 36. Rotary rings (not shown) may be used to effect electrical communication between the rotating acoustic wave energy transducer 12 and a power supply 42 and acoustic wave reorientation apparatus 32. The servomotor may operate in conjunction with sensors and may be controlled by a controller to move the acoustic wave energy transducer 12 in accordance with a treatment plan.

By rotating gantry arm 34, acoustic wave reorientation apparatus 32 modifies a spatial orientation of the acoustic wave propagation axis 16 with respect to the focal point 26. In this particular example, acoustic wave reorientation apparatus 32 moves acoustic wave propagation axis 16 with respect to the focal point locus 40; this means the angular orientation of axis 16 about focal point 26 changes as arm 34 rotates). The acoustic wave propagation axis 16 may constantly intersect the focal point 26 which remains stationary.

Alternatively, the focal point 26 may be allowed to move somewhat (e.g., due to re-focusing of the lens or by moving transducer 12, as will be explained hereinbelow), but the position of focal point 26 is constrained within a locus referred to as the focal point locus 40. Throughout modification of the spatial orientation of the acoustic wave propagation axis 16, the acoustic wave 14 remains focused within the focal point locus 40. Again, as above, the focal point locus 40 may be constrained to the single focal point 26.

Apparatus 10 may be used to carry out extracorporeal shockwave lithotripsy or treatment, wherein the acoustic waves 14 are sent to the target to break up concretions. A goal of such treatment is to concentrate the acoustic waves in the target, and at the same time minimize acoustic energy applied to adjacent healthy tissue. By changing the spatial orientation of the acoustic wave propagation axis 16, while acoustic wave 14 remains focused within the focal point locus 40, this goal is achieved. Thus apparatus 10 serves as a stereotactic acoustic wave generator, similar to LINAC gantries used in stereotactic radiosurgery.

The focal point locus 40 is characterized by a focal region length L (FIG. 3) along the acoustic wave propagation axis 16 and by a focal region width W in a plane perpendicular to the acoustic wave propagation axis 16. In the prior art, since the acoustic wave propagation axis does not change, the focal region length and width are fixed from the start and there is not much that can be done to reduce the length or increase the width. In contrast, in the present invention, the stereotactic procedure spreads the energy (outside the focal point) over a larger volume and reduces focal region length. While applying acoustic energy, apparatus 10 may reorient the acoustic waves 14 such that the focal point 26 is confined to the focal point locus 40 in the treated object. This procedure may spread the acoustic energy over a larger volume and increase focal region width. The invention may be advantageous in minimizing the acoustic energy applied to adjacent healthy tissue.

In accordance with an embodiment of the invention the focusing apparatus 24 may include an acoustic lens. The acoustic wave reorientation apparatus 32 may move the acoustic lens in order to modify the spatial orientation of the acoustic wave propagation axis 16 with respect to the focal point locus 40 (or focal point 26). Moving the acoustic lens is known in the art, for example, from U.S. Pat. No. 5,305,731 to Buchholtz, which describes a generator for acoustic waves that has a liquid lens with a variable focal length which is arranged in the acoustic propagation medium. The liquid lens has two lens walls and a lens liquid is situated therebetween. At least one of the lens walls is deformable for the purpose of varying the focal length. Additionally or alternatively, the acoustic wave reorientation apparatus 32 may move the acoustic reflector 22 in order to modify the spatial orientation of the acoustic wave propagation axis 16 with respect to the focal point locus 40 (or focal point 26). (The focusing apparatus 24 may be considered as comprising the reflector 22; together they modify the generated acoustic waves 14.)

An image acquisition device 44 (e.g., an x-ray or ultrasonic probe fitted in an aperture of reflector 22, as is known in the art) may be provided to acquire images of the focal point locus 40 (or focal point 26). The acoustic wave reorientation apparatus 32 may move the image acquisition device 44, too, with respect to the focal point locus 40 (or focal point 26). An image processor 46 may be used to process images acquired by image acquisition device 44 for display and analysis, as is known in the art.

Reference is now made to FIG. 4, which illustrates an acoustic wave energy delivery device 50, constructed and operative in accordance with another embodiment of the present invention. In this non-limiting embodiment, a plurality of the acoustic wave energy transducers 12 with the corresponding focusing apparatus 24 are arranged about focal point 26 (or focal point locus 40). As before, each acoustic wave energy transducer 12 is capable of generating an acoustic wave which each corresponding focusing apparatus 24 focuses to the focal point 26 (or focal point locus 40). Each acoustic wave energy transducer 12 has a different spatial orientation with respect to the focal point 26 (or focal point locus 40), e.g., each one has a different angle about the focal point 26 (or focal point locus 40). The acoustic wave reorientation apparatus 32 may selectively turn on and off the acoustic wave energy transducers 12 in accordance with a treatment plan. It is appreciated that the selective turning on and off may achieve the same type of acoustic energy delivery as the embodiment of FIGS. 1-3.

It is noted that if two acoustic wave energy transducers 12 are mounted on opposite ends of the gantry arm 34 in FIG. 1, then the acoustic wave reorientation apparatus 32 may selectively turn on and off these two acoustic wave energy transducers 12 in accordance with a treatment plan. In this manner, the features of the embodiment of FIG. 4 may be combined with the features of the embodiment of FIGS. 1-3.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. An acoustic wave energy delivery device comprising:
an acoustic wave energy transducer for generating an acoustic wave along an acoustic wave propagation axis;
focusing apparatus for focusing the acoustic wave to a focal point; and
acoustic wave reorientation apparatus adapted to modify a spatial orientation of said acoustic wave propagation axis with respect to said focal point, wherein a position of said focal point is constrained within a locus referred to as the focal point locus, and throughout modification of the spatial orientation of said acoustic wave propagation axis said acoustic wave remains focused within said focal point locus.

2. The method according to claim 1, wherein said focal point locus is characterized by a focal region length along the acoustic wave propagation axis and by a focal region width in a plane perpendicular to the acoustic wave propagation axis, and said acoustic wave reorientation apparatus is adapted to modify the spatial orientation of said acoustic wave propagation axis so as to reduce the focal region length.

3. The method according to claim 1, wherein said focal point locus is characterized by a focal region length along the acoustic wave propagation axis and by a focal region width in a plane perpendicular to the acoustic wave propagation axis, and said acoustic wave reorientation apparatus is adapted to modify the spatial orientation of said acoustic wave propagation axis so as to increase the focal region width.

4. The acoustic wave energy delivery device according to claim 1, wherein said focal point locus is constrained to a single focal point.

5. The acoustic wave energy delivery device according to claim 1, wherein said acoustic wave reorientation apparatus moves said acoustic wave propagation axis with respect to said focal point locus.

6. The acoustic wave energy delivery device according to claim 1, wherein said acoustic wave energy transducer comprises a plurality of acoustic wave energy transducers with corresponding focusing apparatus, each acoustic wave energy transducer being capable of generating an acoustic wave which each corresponding focusing apparatus focuses to said focal point locus, wherein each acoustic wave energy transducer has a different spatial orientation with respect to said focal point locus, wherein said acoustic wave reorientation apparatus is adapted to selectively turn on and off said acoustic wave energy transducers in accordance with a treatment plan.

7. The acoustic wave energy delivery device according to claim 1, wherein said focusing apparatus comprises an acoustic lens and said acoustic wave reorientation apparatus moves said acoustic lens in order to modify the spatial orientation of said acoustic wave propagation axis with respect to said focal point locus.

8. The acoustic wave energy delivery device according to claim 1, wherein said focusing apparatus comprises an acoustic reflector and said acoustic wave reorientation apparatus moves said acoustic reflector in order to modify the spatial orientation of said acoustic wave propagation axis with respect to said focal point locus.

9. The acoustic wave energy delivery device according to claim 1, further comprising an image acquisition device adapted to acquire images of said focal point locus.

10. The acoustic wave energy delivery device according to claim 9, wherein said acoustic wave reorientation apparatus moves said image acquisition device with respect to said focal point locus.

11. A method for delivery of acoustic wave energy comprising:
generating an acoustic wave along an acoustic wave propagation axis;
focusing the acoustic wave to a focal point; and
modifying a spatial orientation of said acoustic wave propagation axis with respect to said focal point, wherein a position of said focal point is constrained within a locus referred to as the focal point locus, and throughout modification of the spatial orientation of said acoustic wave propagation axis said acoustic wave remains focused within said focal point locus.

12. The method according to claim 11, wherein said focal point locus is characterized by a focal region length along the acoustic wave propagation axis and by a focal region width in a plane perpendicular to the acoustic wave propagation axis, and modifying the spatial orientation of said acoustic wave propagation axis comprises reducing the focal region length.

13. The method according to claim 11, wherein said focal point locus is characterized by a focal region length along the acoustic wave propagation axis and by a focal region width in a plane perpendicular to the acoustic wave propagation axis, and modifying the spatial orientation of said acoustic wave propagation axis comprises increasing the focal region width.
